(19) United States
(12) Patent Application Publication
(10) Pub. No.: US 2002/0087626 A1
(43) Pub. Date: Jul. 4, 2002

(54) Application programming interface for cordless telephones having advanced programmable feature sets

(76) Inventor: Gerhard Siemens, Borken (DE)

Correspondence Address: Siemens Corporation, Intellectual Property Department, 186 Wood Avenue South, Iselin, NJ, 08830, US

(21) Appl. No.: 09/754,904

(22) Filed: Jan. 4, 2001

(51) Int. Cl. G06F 15/16

(52) U.S. Cl. 709/203

(57) ABSTRACT

An application programming interface for cordless telephones having advanced programmable feature sets includes a serial bus interface to the base station of a cordless telephone system, a server application programming interface, a server support layer with installable server modules, client application programming interface, and a client layer with client defined applications. According to the presently preferred embodiment, the API of the invention supports at least five feature classes which include: displaying and scrolling text on handsets, displaying softkeys, edit control for I/O from/to handsets, selection control for selecting features from the feature set, and slider control for providing variable input, e.g. volume controls. The client layer is preferably accessible via VISUAL BASIC commands thereby providing easy access to the MICROSOFT graphical user interface.

### BACKGROUND OF THE INVENTION

1. Field of the Invention

The invention relates to cordless telephones having advanced programmable feature sets. More particularly, the invention relates to an application programming interface for cordless telephones having advanced programmable feature sets.

2. Brief Description of the Prior Art

One of the important socioeconomic changes of the last decade is the rising preponderance of the “home office”. Largely because of advances made in personal computer technology, people are now able to work at home doing things which once required that they travel to an office. People who work in an office now take the opportunity to bring work home. This allows them to spend more time with their family without adversely affecting their productivity. The home office revolution has also given rise to an increasing number of home businesses in which the home office is the only office.

The typically well equipped home office today includes one or more personal computers, a laser printer, a fax machine, a photocopier and two or more phone lines. As a home office grows, it is desirable to connect the computers and printers to a network and increase the number of telephones and telephone lines.

More particularly, it is desirable to provide the same kinds of sophisticated telephony services which are now commonly available in office buildings. Such services include Caller ID, call forwarding, voicemail, conference calling, intercom calls, etc.

In a commercial office building, wiring for networks and sophisticated telephone systems is either pre-installed or easy to install via preinstalled closets and conduits. Most homes, however, are not pre-wired for a computer network, nor are they pre-wired for more than two telephone lines, nor are they equipped for providing the types of sophisticated telephony services available in office buildings.

Many home offices use cordless telephones to avoid the need for wiring new phones and new phone lines. Recently a new class of cordless telephones has been developed. These new phones are based on the DECT (Digitally Enhanced Cordless Telecommunications) standard and offer many of the features previously only available in an office PBX system.

Siemens Corporation has introduced a proprietary version of DECT based telephones called WDCT (Worldwide Digital Cordless Telecommunications). The Siemens telephone sets include a base station transceiver which is coupled to telephone lines and cordless hand sets which access the telephone lines by communicating with the base station transceiver.

The base station transceiver supports multiple phone lines and multiple hand sets. The Siemens system, as do other systems, offers a rich advanced programmable feature set. The features may be programmed via keypress entries from hand sets or via a serial link between a PC and the base station. Due to the sophisticated and extensive nature of the advanced feature set, programming the entire system with keypress entries from a handset is extremely tedious.

Although the PC interface offers a potential solution, there is presently no common interface to program the telephone system other than an extended version of the HAYES AT command set, a cumbersome command line interface originally designed in the 1980s to configure modems.

It would be desirable to provide a simplified interface for programming a wireless telephones having advanced programmable features. However, many vendors disagree as to how such an interface should be implemented.

### SUMMARY OF THE INVENTION

It is therefore an object of the invention to provide an application programming interface for cordless telephones having advanced programmable feature sets.

It is also an object of the invention to provide an application programming interface for cordless telephones having advanced programmable feature sets, which interface is adaptable to meet the needs of a variety of vendors.

It is another object of the invention to provide an application programming interface for cordless telephones having advanced programmable feature sets which interfaces with i.e. an extended AT command set utilized by many cordless telephones.

It is still another object of the invention to provide an application programming interface for cordless telephones having advanced programmable feature sets which interface allows the creation of a graphical user interface to a wireless telephone system.

It is yet another object of the invention to provide an application programming interface for cordless telephones having advanced programmable feature sets which actually extends the feature set of the telephone system.

It is another object of the invention to provide an application programming interface for cordless telephones having advanced programmable feature sets which provides new features whereby PC functionality can interact with the functionality of the telephone system.

In accord with these objects which will be discussed in detail below, the application programming interface for cordless telephones having advanced programmable feature sets according to the invention includes a serial bus interface to the base station of a cordless telephone system, a server application programming interface, a server support layer with installable server modules, client application programming interface, and a client layer with client defined applications.

According to one embodiment, the API of the invention supports at least five feature classes, which include: displaying and scrolling text on handsets, displaying softkeys, edit control for I/O from/to handsets, selection control for selecting features from the feature set, and slider control for providing variable input, e.g. volume controls.

In one embodiment, the client layer is accessible via VISUAL BASIC commands thereby providing easy access to the MICROSOFT graphical user interface.

### BRIEF DESCRIPTION OF THE DRAWINGS

FIG. 1 is a high level block diagram of a base station programmable with the API according to the invention.

FIG. 2 is a schematic diagram of the components of the API of the invention and how they relate to the cordless telephone system.

### DETAILED DESCRIPTION

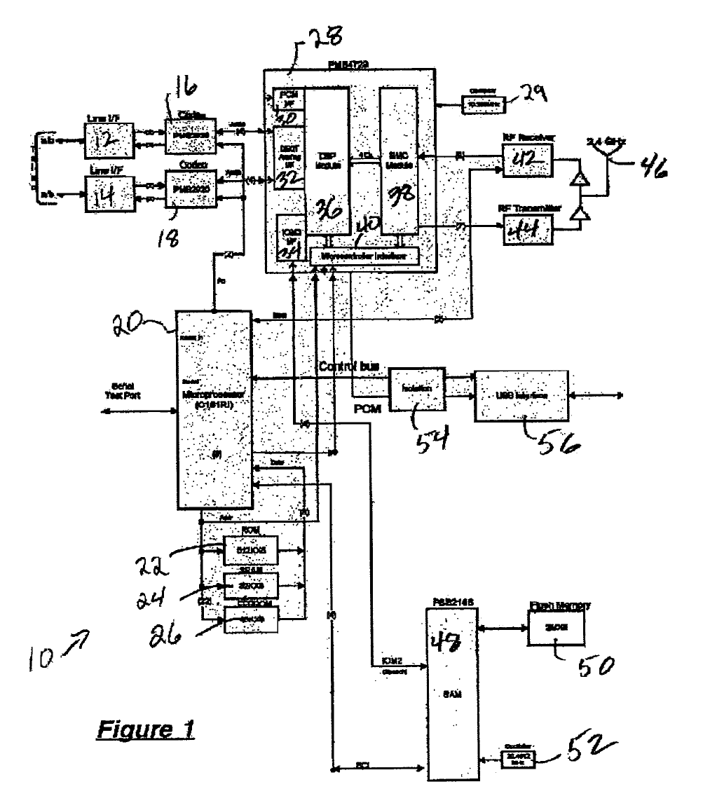

Turning now to FIG. 1, a wireless base station 10 according to the invention includes at least two telco line interfaces 12,14 coupled to respective CODECs 16, 18. The CODECs are controlled by a microprocessor 20 having associated ROM 22, RAM 24, and EPROM 26.

Audio data to/from the CODECs flows through an oscillator section 28, receiver 42, transmitter 44, and antenna 46. The oscillator section 28 is coupled to an external oscillator 29 and includes a PCM oscillator 30, a DECT oscillator 32, and a IOM2 (IOM2 is a Bus Interface with 2 PCM Channels used, for example, in commercially available ISDN phone and chipsets) oscillator 34.

The oscillators are couped to a digital signal processor 36 which is coupled by four channels to a Burst Mode Controller (“BMC”) module 38. The modules 36 and 38 are coupled to a microcontroller interface 40 which is coupled to the microprocessor 20.

A speech recognition module 48 with associated memory 50 and oscillator 52 is coupled to the microprocessor 20 and the oscillator section 28.

According to the invention, an isolation circuit 54 and a USB interface 56 are provided for programming the microprocessor 20.

Further, according to the invention, software is provided for use on a personal computer coupled to the USB interface 56 of the base station 10 of a cordless telephone system. The software of the invention enables access to all of the many programmable features of the telephone system, and allows the user to develop his/her own applications utilizing the features of the telephone system.

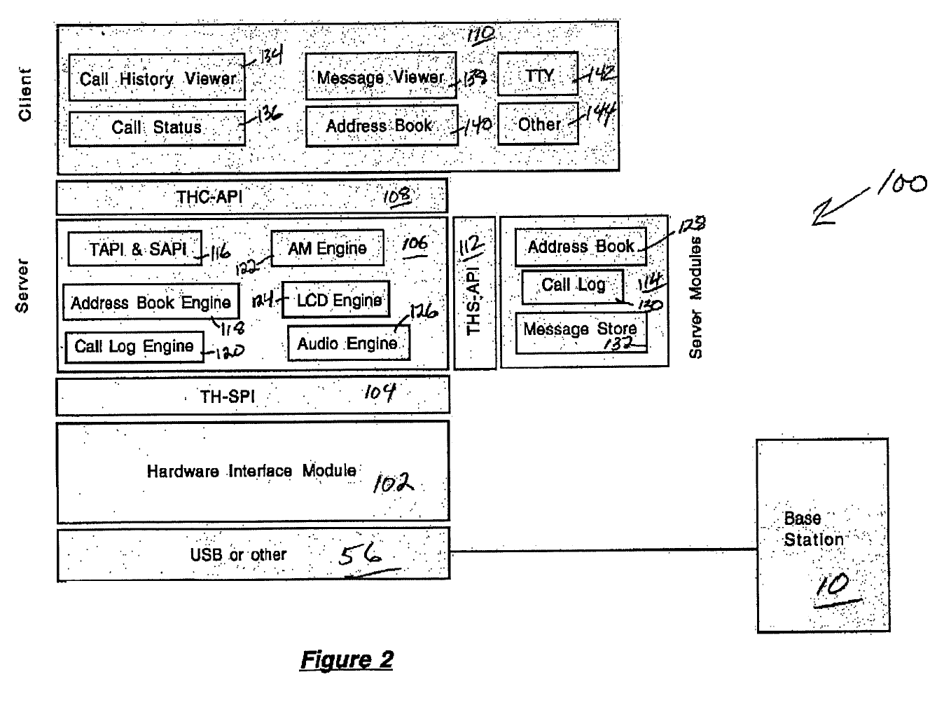

Turning now to FIG. 2, the software system 100 of the invention rests on a hardware interface module 102 which is coupled to the telephone base station 10 via a USB or other interface 56. The hardware interface module 102 supports an extended command set, such as the Hayes AT command set, which is the native programming language of the telephone system. A server programming interface 104 is layered upon the hardware interface 102, whereby server applications 106 may be provided.

A client application programming interface 108 is layered upon the server applications 106 whereby client applications 110 may be provided.

As shown in FIG. 2, the server applications 106 access server modules 114 via a server application programming interface 112.

Exemplary server applications include a standard SAPI & TAPI (Software and Telephony Application Programming Interface) 116, an address book engine 118, a call log engine 120, address management engine 122, an LCD engine 124, and an audio engine 126. Each of these server applications enables access to one or more server modules including the address book 128, the call log 130, and the message store 132.

The address book engine 118 provides an interface to the address book 128 for searching, sorting, editing, etc. The call log engine 120 provides an interface to the call log 130 for searching, sorting, editing, etc. The AM engine 122 provides access to the message store 132 for searching, sorting, editing, etc. The LCD engine 124 provides access to the displays on the remote handsets for messaging, for example. The audio engine 126 is primarily used to play messages from the message store 132 but may also be used to record messages and announcements and for voice recognition applications.

With the above provided server applications, a user may create numerous client applications 110 via the client application programming interface 108 which provides access to the features of the server applications 106. Exemplary client applications include a call history viewer 134, a call status viewer 136, a message viewer 138, an address book editor 140, a text terminal 142, and other applications 144.

The call history viewer 134 allows the user to display data on the PC screen about all recent calls made or received by handsets communicating with the base station. This information may be viewed, sorted, printed, etc., or may be exported to a database application. The call status viewer 136 displays information about telephone calls presently in progress. The message viewer 138 displays data about messages stored in the message store 132, allows messages to be selected and played, deleted, or saved. The address book editor 140 provides user friendly access to the address book 128 with full editing, searching and sorting functions. The text terminal 142 allows the PC user to sent a text message for display on the screen of one or more handsets communicating with the base station. The text terminal can also be used for setting up wake up calls, programming macros, etc.

Each of the client applications 110 may be provided with the same look and feel as a suite of applications from a particular vendor. The client application programming interface 108 according to the invention is preferably accessible from MICROSOFT VISUAL BASIC. The server programming interface could also be accessed through MICROSOFT VISUAL BASIC using Visual Basic Class Objects that offer access to the Telephony Classes; or via C programming language offering a DLL with predefined Function Calls.

As mentioned above, the API of the invention supports at least five feature classes including displaying and scrolling text on handsets, displaying softkeys, edit control for I/O from/to handsets, selection control for selecting features from the feature set, and slider control for providing variable input, e.g. volume controls.

When the PC application makes use of these basic functions, it takes control of a handset by sending a message to it. The handset acknowledges the message and responds to commands until it is commanded to take back control of itself. Preferably, a background application will interrupt the PC control over the hand set when a new call comes in.

According to one embodiment, the API provides complete access to the LCD displays on the hand sets, including pixel access so that trademarks and logos can be displayed, for example.

The API according to the invention allows for complete communication between telephone handsets and a personal computer coupled to the base station. In addition to allowing a personal computer to program and monitor the features of the telephone system, the API can be used to allow the telephone handsets to communicate with the personal computer. Such remote access to the personal computer can be used for home automation, information retrieval, internet access, etc.

There have been described and illustrated herein an application programming interface for cordless telephones having advanced programmable feature sets. While particular embodiments of the invention have been described, it is not intended that the invention be limited thereto, as it is intended that the invention be as broad in scope as the art will allow and that the specification be read likewise. It will therefore be appreciated by those skilled in the art that yet other modifications could be made to the provided invention without deviating from its spirit and scope as so claimed.

What is claimed is:

1. An application programming interface for a cordless telephone having an advanced programmable feature set, said interface comprising:
(a) a hardware interface module for communicating with the telephone in the telephone's native programming language;
(b) a server programming interface for layering installable server modules over the hardware interface module;
(c) a plurality of server modules overlying said server programming interface; and
(d) a client application programming interface overlying said server modules enabling a client to write an application which utilizes functionality provided by said server modules.

2. An application programming interface according to claim 1 wherein said installable server modules provide access to an address book, a call log, and a message store.

3. An application programming interface according to claim 2 wherein said installable server modules are selected from the group consisting of an address book engine, a call log engine, an LCD engine, an audio engine, and a message store management engine.

4. An application programming interface according to claim 3 wherein access is, provided to at least five classes of features including displaying and scrolling text on handsets, displaying softkeys, edit control for I/O from/to handsets, selection control for selecting features from the feature set, and slider control for providing variable input.

5. An application programming interface according to claim 4 wherein said client application programming interface is accessible via VISUAL BASIC.

6. An application programming interface according to claim 5 wherein said client application programming interface supports applications selected from the list consisting of a call history viewer, a call status viewer, a message viewer, an address book editor, an a text terminal.

7. A method for programming a cordless telephone having an advanced programmable feature set, comprising the steps of:
(a) providing a hardware interface module for communicating with the telephone in the telephone's native programming language;
(b) providing a server programming interface for layering installable server modules over the hardware interface module; and
(c) providing a client application programming interface overlying the server modules enabling a client to write an application which utilizes functionality provided by the server modules.

8. A method according to claim 7 wherein the installable server modules provide access to an address book, a call log, and a message store.

9. A method according to claim 8 wherein the installable server modules are selected from the group consisting of an address book engine, a call log engine, an LCD engine, an audio engine, and a message store management engine.

10. A method according to claim 9 further comprising the step of providing access to at least five classes of features including displaying and scrolling text on handsets, displaying softkeys, edit control for I/O from/to handsets, selection control for selecting features from the feature set, and slider control for providing variable input.

11. A method according to claim 10 wherein the client application programming interface is accessible via VISUAL BASIC.

12. A method according to claim 11, wherein the client application programming interface supports applications selected from the list consisting of a call history viewer, a call status viewer, a message viewer, an address book editor, and a text terminal.
